(19) United States
(12) Patent Application Publication
(10) Pub. No.: US 2018/0137091 A1
(43) Pub. Date: May 17, 2018

(54) FRAMEWORK FOR AGGREGATING DEFAULT AND OVERRIDING CONTENT FROM MULTIPLE SOURCES

(71) Applicant: Microsoft Technology Licensing, LLC, Redmond, WA (US)

(72) Inventors: Muhammad Omer Iqbal, Redmond, WA (US); Swaroop Krishnamurthy, Bellevue, WA (US); Srinivas Nadimpalli, Bellevue, WA (US); Brandon Brian Murdoch, Reading (GB); Muhammad Zaman, Bellevue, WA (US)

(21) Appl. No.: 15/413,392

(22) Filed: Jan. 23, 2017

Related U.S. Application Data
(60) Provisional application No. 62/423,698, filed on Nov. 17, 2016.

(51) Int. Cl. G06F 17/22; G06F 17/28; G06F 17/21; G06F 17/30

(52) U.S. Cl. CPC G06F 17/2288; G06F 17/28; G06F 17/2247; H04L 67/02; G06F 17/211; G06F 17/30899; G06F 17/3089; G06F 17/2235

(57) ABSTRACT

A method and system is provided for customizing a web page of an application of an application provider. A host (e.g., cloud service), which hosts the application, provides the web page to a user of the application provider on behalf of the application provider. A customization system receives from a user of the application provider a request for the web page, which has content. The customization system identifies a preferred language for the content of the web page. When the application provider has specified content for the preferred language for the web page, the customization system adds to the web page the specified content. When the application provider has not specified content for the preferred language for the web page, the customization system adds to the web page default content in the preferred language provided by the host.

### CROSS-REFERENCE TO RELATED APPLICATION

This application claims the benefit of U.S. Provisional Application No. 62/423,698, filed on Nov. 17, 2016, which is hereby incorporated by reference in its entirety.

### BACKGROUND

A cloud service may have many thousands of servers and storage devices and may provide various software products such as operating systems, databases, applications, identity services, backup services, and so on to its customers. Rather than maintaining their own data centers, many enterprises subscribe as customers of a cloud service for hosting their applications. For example, if a customer provides an electronic commerce web site, the cloud service would store the web pages of the web site and serve the web pages to clients or users of the customer. As another example, an enterprise with employees throughout the world may host various business applications on a cloud service. The employees with proper authentication can then access the business applications.

A customer of a cloud service may take advantage of various services provided by the cloud service. For example, a cloud service may provide a checkout service for its customers who have electronic commerce applications. When a user of the customer wants to pay for their electronic commerce purchases, the customer's electronic commerce application provides the transaction information (e.g., sales amount) to the checkout service. The checkout service collects payment information (e.g., credit card information) from the user, interfaces with the user's financial institution to complete the payment, and notifies the application that the payment was successful. As another example, customers may rely on an identity service provided by the cloud service to authenticate their users. When a user accesses the main web page of the customer's web site (e.g., “acme.com”) using a browser, the main web page may include a sign-in link (e.g., button) to a web page of the identity service of the cloud service. When the user click on the sign-in link, the browser sends a request to the identity service that identifies the customer's application. The identity service then responds with a sign-in web page that may ask for a user name and password, referred to as asking for a “claim” of the user's identity. When the user provides the claim, the identity service authenticates the user and then generates an authentication token that can be used as proof that the claim has been verified—that is, the user has been authenticated.

A cloud service may provide various language options for the services so that content of web pages are provided in languages that each user would expect to see. For example, the cloud service may provide web pages in different languages for its identity service. When a user clicks on a sign-in link, the request that is sent to the identify service may specify the language specified by the customer's application or the language of the browser's environment. The identity service can then use the language to serve the web page in an appropriate language. For example, if the language of the browser is the Canadian variant of French, the identity service may serve a web page in the Canadian variant of French. If a web page in that variant is not available, the identity service may serve a web page in the French language. Unfortunately, a cloud service may use a language that a user would not expect. For example, if a customer's application is being accessed by someone in Canada and the user interface of the customer's application is in Chinese, then the presenting of a main web page and subsequent web pages in Chinese while the sign-in web page is in French may be a less than desirable user experience.

### SUMMARY

A method and system is provided for customizing a web page provided by a host (e.g., cloud service) that hosts application of application providers (e.g., customers of the cloud service). The host provides the web page to a user of the application provider on behalf of the application provider. A customization system receives from a user of the application provider a request for the web page, which has content. The customization system identifies a preferred language for the content of the web page. When the application provider has specified content for the preferred language for the web page, the customization system adds to the web page the specified content. When the application provider has not specified content for the preferred language for the web page, the customization system adds to the web page default content provided by the host, which may be in the preferred language or may be in an overriding language.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

FIG. 1A illustrates a sign-in web page with default content provided by a host in some embodiments.

FIG. 1B illustrates a sign-in web page with overriding content provided by an application provider of a host in some embodiments.

FIG. 2 illustrates a support web page for an application provider to identify languages and to download and upload overriding content in some embodiments.

FIG. 3 illustrates an upload override web page for an application provider to upload overriding content in some embodiments.

FIG. 4 illustrates a web page for generating overriding content in some embodiments.

FIG. 5 illustrates a web page for uploading content for a new language in some embodiments.

FIG. 6 illustrates a web page for establishing a path of priority of languages in some embodiments.

FIG. 7 is a flow diagram that illustrates the customizing of a web page by a customize web page component of the customization system of a host in some embodiments.

FIG. 8 is a block diagram that illustrates components of the customization system in some embodiments.

FIG. 9 is a flow diagram that illustrates processing of a select preferred language component of the customization system in some embodiments.

FIG. 10 is a flow diagram that illustrates processing of a retrieve content component of a customization system in some embodiments.

FIG. 11 is a hierarchy diagram illustrating a hierarchy of content defined by a host and application providers in some embodiments.

FIG. 12 is a flow diagram that illustrates processing of a retrieve content component using a hierarchy of overriding content in some embodiments.

### DETAILED DESCRIPTION

A method and system for customization of a document (e.g., a web page) provided by a service of a host is provided. In some embodiments, a customization system provided by a host (e.g., cloud service) receives an indication to customize a web page that is to be provided to a user of an application provider (e.g., customer) of the host. For example, the indication may be a request sent in response to the user clicking on a sign-in link on a main web page of the application provider. The web page to be customized may have associated content identifiers that identify the content that is to be included on the web page. For example, a user name field may have a content identifier for content that is to be displayed as the label (e.g., “Enter User Name”) for the field and a content identifier for content to be displayed as an error message (e.g., “Invalid User Name”) when an error is detected for the field. The host may provide different sets of content, referred to as default content that may be appropriate for a web page depending on the context of the access to the web page. For example, the host may provide content in various languages, directed to different age groups, directed to different professions, and so on for the web page. The host selects the content that is most appropriate given the context. For example, the host may select one set of content if the user is 20 years old and a different set of content if the user is 60 years old. The customization system allows an application provider to provide content that overrides the default content of the host. For example, users of some application providers may prefer the error message “Incorrect User Name,” rather than “Invalid User Name,” because “invalid” is a homograph with a meaning that might be considered offensive by some users. In such a case, the application provider may provide content that maps the content identifier for the error message to the content “Incorrect User Name.” When the host receives, from a user of an application provider, a request for the web page, the customization system determines whether the application provider has provided at least some overriding content for the web page. If so, the customization system checks the overriding content to determine whether each content identifier for the web page is included in the overriding content. If a content identifier is included in the overriding content, the customization system adds the content for that content identifier of the overriding content to the web page. If the content identifier is not included in the overriding content, the customization system adds the content for that content identifier of the default content to the web page. The customization system thus allows an application provider to customize the content of a web page provided by the host on behalf of the application provider in a manner that is consistent with a policy for selecting overriding content as specified by the application provider. In this way, the users of the application provider are provided a web page by the host that is more consistent with the web pages provided by the application provider (e.g., in the same language or language variant).

Although the customization system is described primarily in the context of providing content in different languages and for web pages, the customization system may be used to provide custom content in the same language and for documents other than web pages, such as forms to be printed or electronic forms. The content can include strings of text, image content, audio content, video content, graphics content, and so on.

In some embodiments, the customization system may use a concept similar to inheritance of object-oriented programming, resolving a content identifier to its corresponding content. A dependent language (e.g., variant) of another language may be considered to inherit content of the other language that is not specified by the dependent language. For example, content for French may include a display name for a user name field and a password field, and content for French-Canadian may include a display name for the user name field, but not for the password field. In such a case, if French-Canadian is the preferred language, then the customization system will resolve the display name for the user name field to the content for French-Canadian, but will resolve the password field to the content for French since the content for French-Canadian did not include the display name for the password field. The customization system may allow for any level of dependencies. For example, French-Creole may depend on French-Canadian, which may depend on French, which may depend on English-Canadian, and so on. The customization system may support a tree structure type dependency in which each language has only one path to the root language. Alternatively, each most dependent language may have its own path of dependent languages. For example, the path for French-Canadian may be to French-Quebec and then to French, but the path for French-Creole may be to French-Canadian and then to French. In one path, French-Canadian depends directly on French-Quebec, and in the other path, French-Canadian depends directly on French. A language that is dependent on another language is an overriding language, and the other language is an overridden language. The paths define a priority ordering of the languages. In some embodiments, the customization system, for each language on the path, may first determine whether the application provider has provided overriding content for that path for the language. If the overriding content provides content for the content identifier, the customization system uses that content. If no overriding content is provided for the language or if the overriding does not provide content for the content identifier, then the customization system determines whether default content has been provided for the language. If so, the customization system uses content (if any) for the content identifier from the default content for the language. Otherwise, the customization system tries to resolve the content identifier using content for the next language in the path.

In some embodiments, the customization system may perform the customization of a web page on the server side or the client side. When performed on the client side, the customization system may provide a client side component that is stored on client devices of users or downloaded on demand to client devices. When a browser executing on a client device receives a web page provided by the host on behalf of an application provider, the client-side component is invoked to resolve the content identifier of the web page to the appropriate content. In such a case, the overriding content may be stored on the client device or external to the client device, and the default content may be stored at the host. The client-side component may resolve the content identifiers in a manner similar to that of a server-side component of the customization system.

In some embodiments, the customization system allows default content and overriding content to be stored in various data sources at disparate locations. For example, a cloud service may specify that some default content for English is stored at a server provided by the cloud service and that other default content for English or default content for French is stored at a server of a third party. Similarly, an application provider may specify that overriding content for English is stored at a server provided by the cloud service and that overriding content for French-Canadian is stored at server of a third party. In this way, the customization system does not need to store all the content locally, but rather can retrieve content from the various data sources in real time when web pages are customized and served.

In some embodiments, the customization system may store default content and overriding content in an eXtensible Markup Language (“XML”) format. Table 1 contains excerpts from an example of default content for a sign-up web page.

TABLE 1
<Localization Variant=“en-us”>
<LocalizationMetadata>

<Application providerId>host.com</Application providerId>
<SubjectId>SIGNUP</SubjectId>

</LocalizationMetadata>
<LocalizedStrings>
. . .

<LocalizedString ElementType=“ClaimType”

ElementId=“signInNamesInfo.emailAddress” StringId=“DisplayName”>Email
Address</LocalizedString>

<LocalizedString ElementType=“ClaimType”

ElementId=“signInNamesInfo.emailAddress” StringId=“AdminHelpText”> Email
address that the user can use to sign in.</LocalizedString>

<LocalizedString ElementType=“ClaimType” ElementId=“signInNamesInfo.

emailAddress” StringId=“UserHelpText”>Email address to use for signing
in.</LocalizedString>

<LocalizedString ElementType=“ClaimType” ElementId=“password” StringId=

“DisplayName”>Password</LocalizedString>

<LocalizedString ElementType=“ClaimType” ElementId=“password” StringId=

“AdminHelpText”>Enter password</LocalizedString>

<LocalizedString ElementType=“ClaimType” ElementId=“password” StringId=

“UserHelpText”>Enter password</LocalizedString>

<LocalizedString ElementType=“TechnicalProfile” ElementId=“AB-OAUTH”

StringId=“DisplayName”>AB</LocalizedString>

<LocalizedString ElementType=“TechnicalProfile” ElementId=“Go-OAUTH”

StringId=“DisplayName”>Go</LocalizedString>

<LocalizedString ElementType=“TechnicalProfile” ElementId= “LocalAccountSignIn”

StringId=“DisplayName”>Local Account SignIn</LocalizedString>

<LocalizedString ElementType=“TechnicalProfile” ElementId=“Self Asserted”

StringId=“verifying_blurb”>Hold on while we finish setting up your account and
signing you in</LocalizedString>

<LocalizedString ElementType=“TechnicalProfile” ElementId=“Self Asserted”

StringId=“button_cancel”>Cancel</LocalizedString>

<LocalizedString ElementType=“TechnicalProfile” ElementId=“PhoneFactor”

StringId=“error_tryagain”>The phone number you provided is busy or
unavailable. Please check the number and try again.</LocalizedString>

<LocalizedString ElementType=“TechnicalProfile” ElementId=“PhoneFactor”

StringId=“error_incorrect_code”>The verification code you have entered does
not match our records. Please try again, or request a new verification
code.</LocalizedString>

. . .
</LocalizedStrings>

<LocalizedCollections>

<LocalizedCollection ElementType=“ClaimType” ElementId=“country”

TargetCollection=“Restriction”>
<Item Text=“Afghanistan” Value=“Afghanistan” />
<Item Text=“Åland Islands” Value=“Åland Islands” />
. . .
<Item Text=“United Kingdom” Value=“United Kingdom” />
<Item Text=“United States” Value=“United States” />

. . .
</LocalizedCollection>

</LocalizedCollections>
</Localization>

Each LocalizedString tag specifies content for a content identifier. For example, the following tag

<LocalizedString ElementType=“ClaimType”

ElementId=“signInNamesInfo.emailAddress”
StringId=“DisplayName”>Email Address</LocalizedString>

specifies that the content, that is, the string “Email Address,” is associated with the content identifier, that is, a combination of the values for the ElementType, ElementId, and StringId elements. In this example, the ElementID of “signInNamesInfo.emailAddress” means that the content relates to an email identity and the StringId of “DisplayName” indicates that the content is to be displayed as a name of a field for entry of the identity. Table 2 provides a description of the tag, and Table 3 provides a description of the elements of the tags.

TABLE 2

| Tags | Elements | Description |
|---|---|---|
| Localization | Variant | Encloses localization content |
| | | for an application provider |
| | | and a subject |
| LocalizationMetadata | | Encloses localization metadata |
| | | that identifies the application |
| | | provider and the subject |
| ApplicationProviderId | | Identifies the application |
| | | provider |
| SubjectId | | Identifies the subject (e.g., |
| | | sign-in or sign up process) to |
| | | which the localization content |
| | | applies |
| LocalizedStrings | | Encloses the localized strings |
| | | that can be overridden by an |
| | | application provider |
| LocalizedString | ElementType | Encloses one localized string |
| | ElementId | that maps a content identifier |
| | StringId | to its content |
| LocalizedCollections | | Encloses collections of |
| | | localized values for one |
| | | element (e.g., for a drop-down |
| | | list) that can be overridden |
| | | by an application provider |
| LocalizedCollection | ElementType | Encloses a collection of |
| | ElementId | localized data |
| | TargetCollection | |
| Item | Text | Encloses an element of a |
| | Value | collection |

TABLE 3

| Elements | Description |
|---|---|
| Variant | Language and variant (e.g., “en-us” for the U.S. |
| | variant of English) |
| ElementType | Identifies the element type of the content |
| ElementId | Identifies the element identifier of the content |
| StringId | Identifies the string identifier of the content |
| TargetCollection | Identifies a collection of values for items |
| Text | Display string for an item in a collection |
| Value | Value of an item in a collection to identify a |
| | selection to a program |

Table 4 contains excerpts from an example of overriding content for a sign-up web page that overrides default content of Table 1. For example, the string “Please wait while we create your account” overrides the content “Hold on while we finish setting up your account and signing you in.”

TABLE 4
Localization Variant=“en-us”>
<LocalizationMetadata>

<Application providerId>acme.host.com</Application providerId>
<SubjectId>SIGNUP</SubjectId>

</LocalizationMetadata>
<LocalizedStrings>

<LocalizedString ElementType=“ClaimType” ElementId=“password”

StringId=“DisplayName”>Pwd</LocalizedString>

<LocalizedString ElementType=“ClaimType” ElementId=“password”

StringId=“UserHelpText”>Pwd</LocalizedString>

<LocalizedString ElementType=“TechnicalProfile”

ElementId=“Self Asserted” StringId=“verifying_blurb”>Please
wait while we create your account</LocalizedString>

</LocalizedStrings>
</Localization>

In some embodiments, the customization system may collect the default content from various resources of the service that it provides to its application providers. The content of the resources may be in a default language of the cloud service. For example, the customization system may collect error strings from Java script, messages from configuration files, labels from web pages, and so on. The customization may then generate an XML file for the default content. The customization system may allow corresponding default content in different languages to be provided for the cloud service.

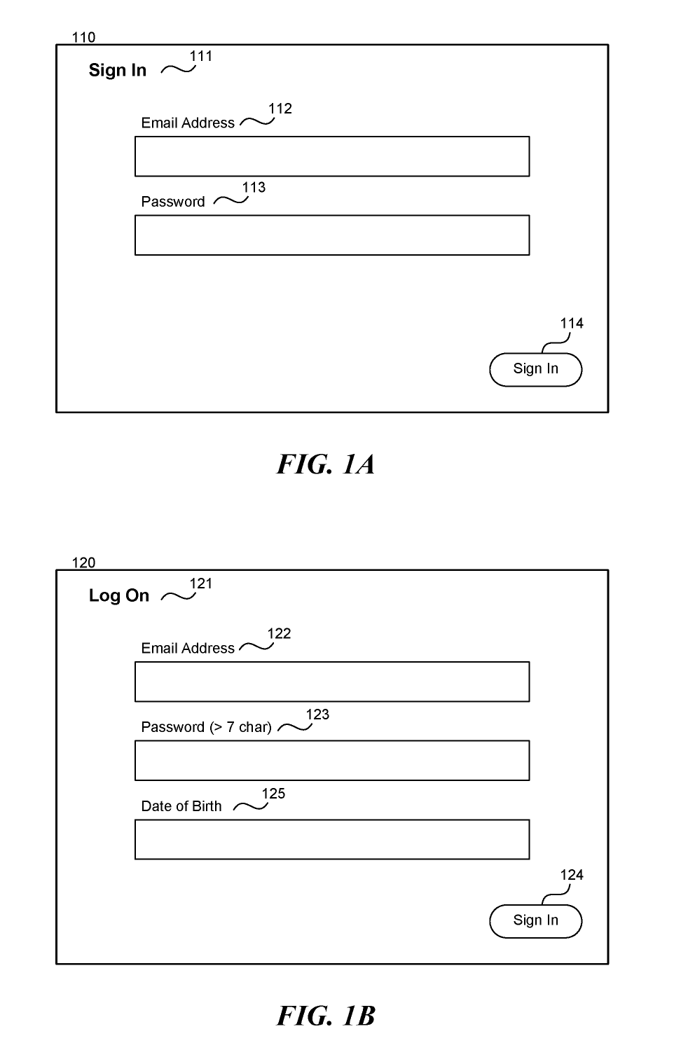

FIG. 1A illustrates a sign-in web page with default content provided by a host in some embodiments. A web page 110 includes header content 111, username content 112, password content 113, and button content 114. The header content indicates that this web page is for signing into the application provider's application. The user name content indicates that the user is to enter an email address as the user name. The password content indicates that the user is to enter a password. The button content indicates that the user is to select the button to sign in to the application provider's application.

FIG. 1B illustrates a sign-in web page with overriding content provided by an application provider in some embodiments. A web page 120 includes header content 121, user name content 122, password content 123, button content 124, and custom field content 125. In this example, the application provider has provided content to override the default header content and password content. In addition, the application provider has added a date of birth field to the sign-in web page along with custom content for the date of birth field.

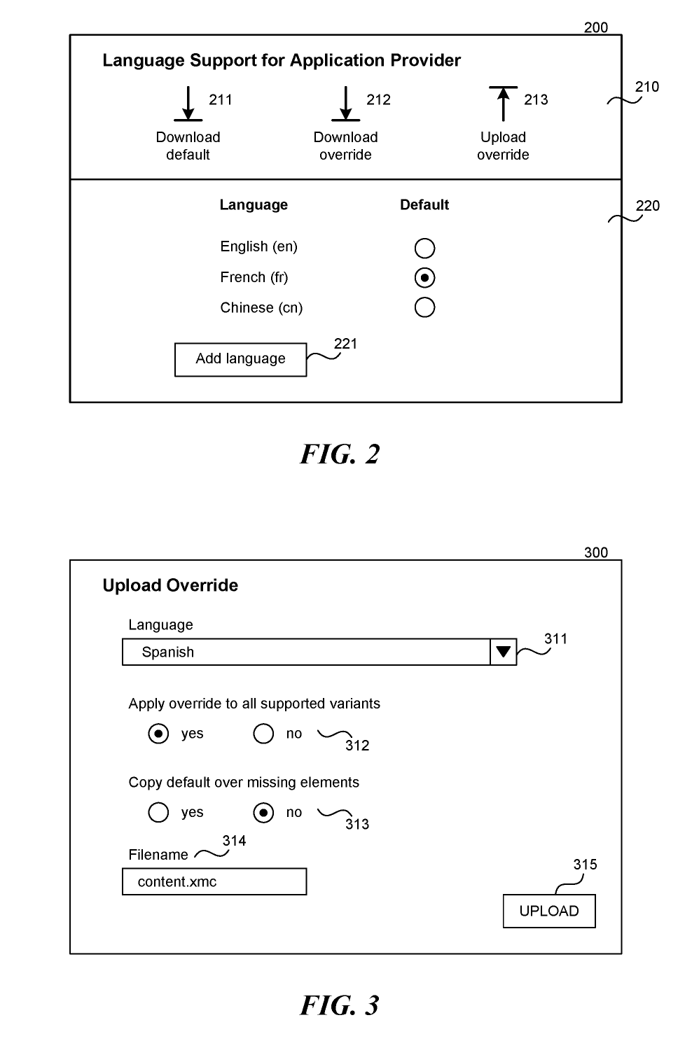

FIG. 2 illustrates a support web page for an application provider to identify languages and to download and upload overriding content in some embodiments. A web page 200 includes a download/upload area 210 and a language specification area 220 to define the policy of an application provider relating to overriding content. The download/upload area includes a download default icon 211, a download override icon 212, and an upload override icon 213. The download default icon allows an application provider to download an XML file that contains the default content for a specified language. The download override icon allows an application provider to download an XML file that contains the overriding content for specific language that the application provider uploaded. The upload override icon allows an application provider to upload an XML file containing override content for the application provider. The language specification area allows an application provider to identify the languages to be used by the customization system, that is, the languages that are acceptable to the application provider. In this example, the application provider has specified that the languages are English, French, and Chinese and that French is the default language. When the customization system determines that the preferred language is English, French, or Chinese, then the customization system uses the default content in the preferred language provided by the host—assuming the application provider has not provided overriding content for the preferred language. If the preferred language is not one of these three languages, then the customization system uses the default content for the default language, which is French. The add language button 221 allows an application provider to add additional languages to be provided to its users.

FIG. 3 illustrates an upload override web page for an application provider to upload overriding content in some embodiments. A web page 300 includes a language specification drop-down list 311, a variants button 312, a copy button 313, a filename field 314, and an upload button 315. When an application provider decides to upload overriding content, the application provider selects the language using the drop-down list 311. The variants button allows the application provider to indicate whether the uploaded overriding content is to override all variants of the selected language. In this example, the uploaded overriding content is specified to be in Spanish, which would override content for the variant Spanish-Mexican. The copy button allows an application provider to specify whether any missing content of the uploaded overriding content should be copied from the default content for the selected language. The filename field allows the application provider to enter the filename that contains the overriding content. The application provider may enter the file name as a uniform resource identifier when the overriding content is stored on a remote server. The application provider selects the upload button to upload the overriding content.

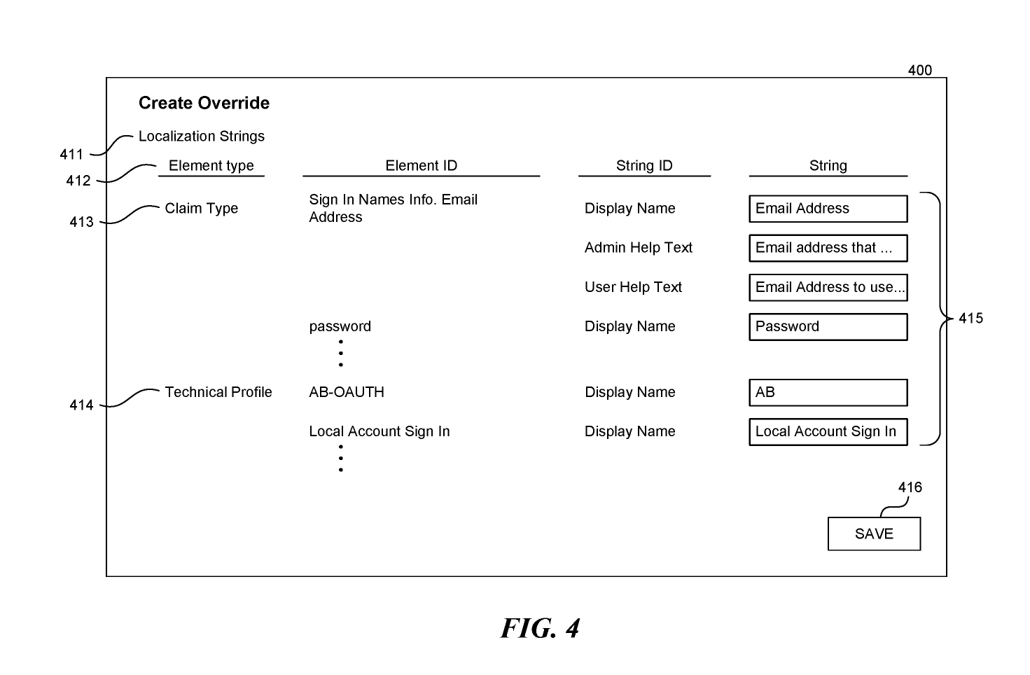

FIG. 4 illustrates a web page for generating overriding content in some embodiments. A web page 400 displays an XML file in an outline form. Headings 411-412 list the various tags and elements of the XML file. Areas 413-414 list the content identifiers. Text boxes 415 contain the current content for the overriding content for each content identifier. An application provider can edit the content in each text box as desired. The application provider selects the save button 416 to save the overriding content in an XML file, which can then be uploaded using the web page of FIG. 3.

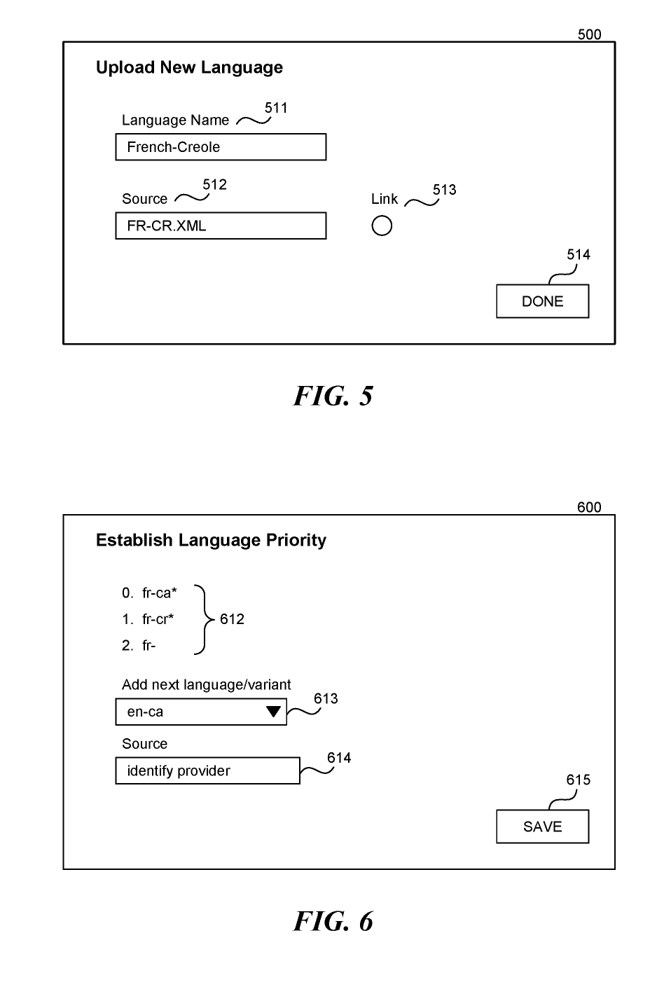

FIG. 5 illustrates a web page for uploading content for a new language in some embodiments. The customization system may allow the application provider to define content for a language that is not provided as part of the languages provided by the customization system. For example, an application provider may provide content for French-Creole. A web page 500 includes a language name field 511, a source field 512, a link button 513, and a done button 514. After creating an XML file that contains the content for the new language, the application provider enters the name of the language in the language name field and the name of the XML file in the source field. If the application provider wants the customization system not to upload the content but rather to access the content that is stored external to the customization system, the application provider selects the link button. The application provider then selects a done button to provide the content to the customization system.

FIG. 6 illustrates a web page for establishing a path of priority of languages in some embodiments. A web page 600 includes a language selection drop-down list 613 and a content source text box 614. The content source specifies whether the content for the language is provided by the application provider or the service of the host. As an application provider enters languages of the path, the languages are listed in the path area 612. In this example, the application provider has entered French-Canadian (“fr-ca*”), French-Quebec (“fr-cr”), and French (“fr-”). The asterisk indicates that the content for the language is that provided by the application provider. An application provider selects the save button 615 to save the path. The web page may also provide options for re-ordering the languages, deleting languages, and so on.

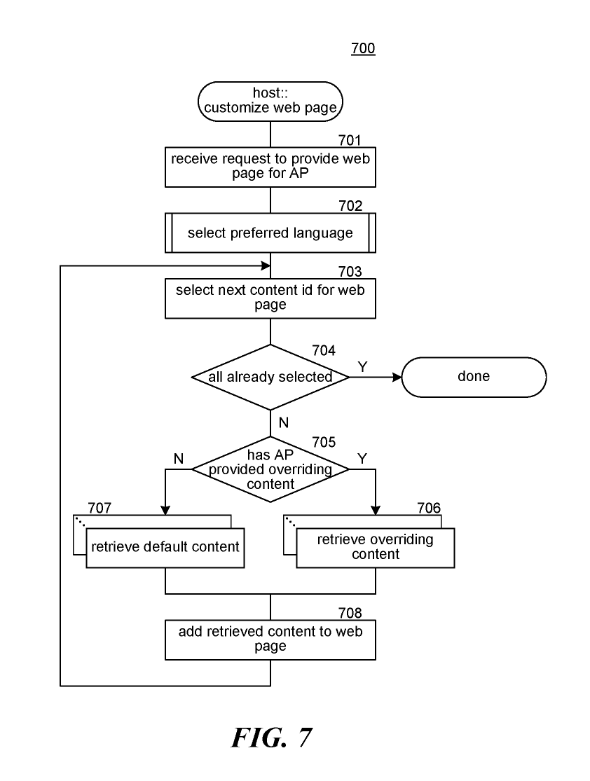

FIG. 7 is a flow diagram that illustrates the customizing of a web page by a customize web page component of the customization system of a host in some embodiments. A customize web page component 700 is invoked when the host receives a request to provide a web page on behalf of an application provider (“AP”). In block 701, the component receives the request to provide the web page on behalf of the application provider. In block 702, the component may invoke a select preferred language component to identify the preferred language for the user. In blocks 703-708, the component loops resolving each content identifier for the web page. In block 703, the component selects the next content identifier for the web page. In decision block 704, if all the content identifiers have already been selected, then the component completes, else the component continues at block 705. In decision block 705, if the application provider has provided overriding content (e.g., in the preferred language) for the selected content identifier, then the component continues at block 706 to retrieve the overriding content for the selected content identifier, else the component continues at block 707 to retrieve the default content (e.g., in the preferred language) for the selected content identifier. In each of blocks 706 and 707, the component may access multiple data sources to identify and retrieve the content for the selected content identifier. For example, an application provider may specify a first data source of overriding content (e.g., in French-Creole) that it defined for some content identifiers and may specify a second data source of overriding content (e.g., in French-Canadian) that a third party defined for all content identifiers. In such a case, the component would initially access to first data source to see if it specifies overriding content for the selected content identifier. If so, the component uses that overriding content. If not, the component would next access the second data source to see if it specifies overriding content for the selected content identifier. If so, the component uses that overriding content. In block 708, the component adds the retrieved content to the web page and then loops to block 703 to select the next content identifier for the web page.

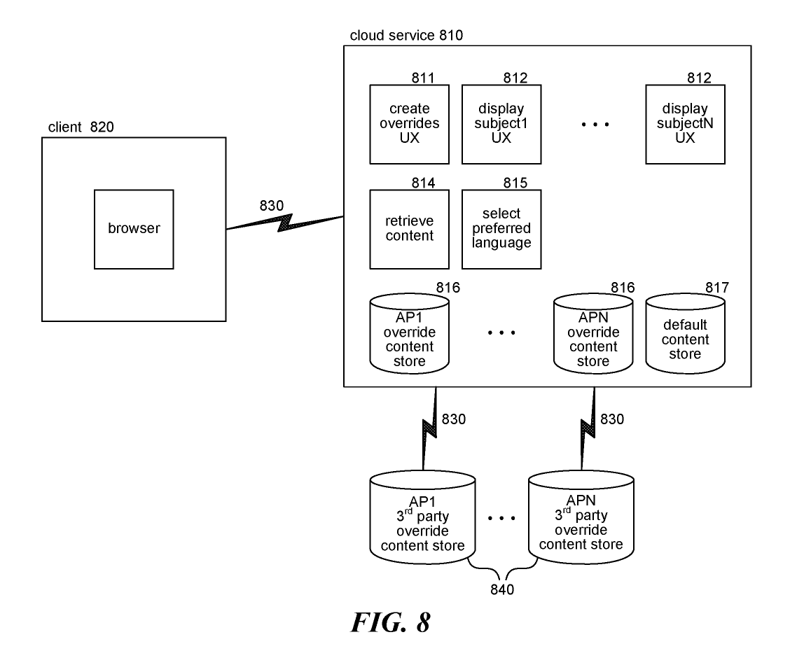

FIG. 8 is a block diagram that illustrates components of the customization system in some embodiments. A cloud service 810 is connected to one or more client devices 820 (with browsers 821) of users via communications link 830. The cloud service may also be connected to various third-party overriding content stores 840 for application providers via the communications link. The cloud service includes a create overrides UX component 811 and display subject UX components 812. The cloud service also includes a retrieve content component 814 and a select preferred language component 815. The cloud service includes application provider override content stores 816 and a default content store 817. The create overrides UX component provides the primary user experience for an application provider to generate and upload overriding content. The display subject UX components control the displaying of web pages related to specific subjects when a request is received from a user of an application provider. The display subject UX components invoke the select preferred language component to identify a preferred language for the web page and invoke the retrieve content component to retrieve content for a designated content identifier. The application provider override content stores store the overriding content for the application providers. The default content store stores the default content that is provided by the host. The application provider third party override content stores store content provided by a third-party on behalf of an application provider. For example, a third party may create overriding content for French-Creole and make that content available for a price to various application providers of the cloud service. An application provider can direct the customization system to retrieve the overriding content from a server of the third party. More generally, the customization system may allow an application provider to specify that its overriding content is to be retrieved from various data sources at disparate locations.

The computing systems on which the customization system may be implemented may include a central processing unit, input devices, output devices (e.g., display devices and speakers), storage devices (e.g., memory and disk drives), network interfaces, graphics processing units, accelerometers, cellular radio link interfaces, global positioning system devices, and so on. The input devices may include keyboards, pointing devices, touch screens, gesture recognition devices (e.g., for air gestures), head and eye tracking devices, microphones for voice recognition, and so on. The computing systems may include servers of a data center, massively parallel systems, and so on. The computing systems may access computer-readable media that include computer-readable storage media and data transmission media. The computer-readable storage media are tangible storage means that do not include a transitory, propagating signal. Examples of computer-readable storage media include memory such as primary memory, cache memory, and secondary memory (e.g., DVD) and other storage. The computer-readable storage media may have data recorded on them or may be encoded with computer-executable instructions or logic that implements the customization system. The data transmission media are used for transmitting data via transitory, propagating signals or carrier waves (e.g., electromagnetism) via a wired or wireless connection.

The customization system may be described in the general context of computer-executable instructions, such as program modules and components, executed by one or more computers, processors, or other devices. Generally, program modules or components include routines, programs, objects, data structures, and so on that perform particular tasks or implement particular data types. Typically, the functionality of the program modules may be combined or distributed as desired in various examples. Aspects of the customization system may be implemented in hardware using, for example, an application-specific integrated circuit (ASIC).

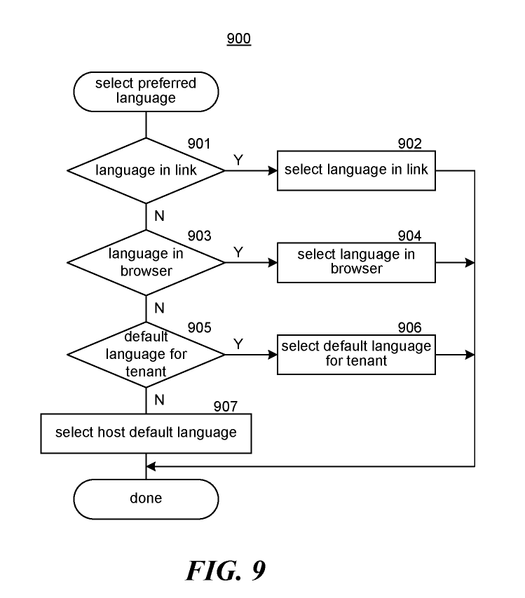

FIG. 9 is a flow diagram that illustrates processing of a select preferred language component of the customization system in some embodiments. A select preferred language component 900 is invoked to identify a preferred language for a web page. The preferred language may be identified in various ways such as by determining the default language specified for the user's browser. In decision block 901, if a language is specified in the link that the user selects to access the web page and the language is one of the languages specified by the application provider (e.g., FIG. 2), then the component continues at block 902, else the component continues at block 903. When an application provider wants a specific preferred language for a user, the application provider can add the language to the link that is provided to retrieve the web page provided by the host. In block 902, the component selects the language of the link as the preferred language and then completes. In decision block 903, if a language is specified for the browser and the language is one of the languages specified by the application provider (e.g., FIG. 2), then the component continues at block 904, else the component continues at block 905. In block 904, the component selects the language of the browser as the preferred language and then completes. In decision block 905, if the application provider has specified a default language (e.g., FIG. 2), then the component continues at block 906, else the component continues at block 907. In block 906, the component selects the default language provided for the application provider as the preferred language and completes. In block 907, the component selects the default language provided by the host as the preferred language and completes.

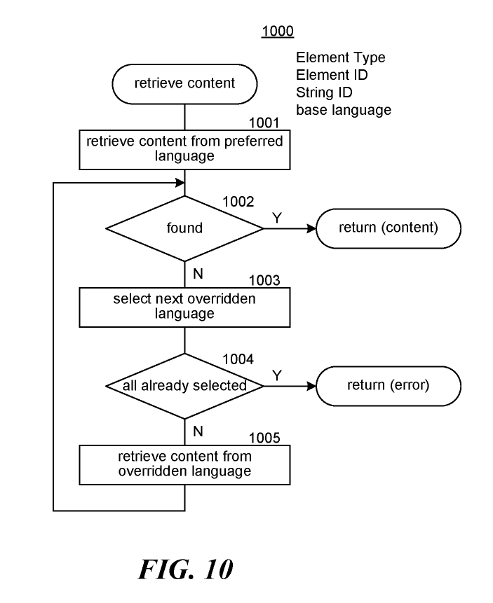

FIG. 10 is a flow diagram that illustrates processing of a retrieve content component of a customization system in some embodiments. A retrieve content component 1000 is invoked to retrieve the content for a specific content identifier, which is passed to the component. A content identifier may be a combination of an element type, element identifier, and string identifier. The preferred language may also be passed to the component. In block 1001, the component retrieves the content for the content identifier from the content for the preferred language. In decision block 1002, if the content for the content identifier is found in the content, then the component returns the retrieved content, else the component continues at block 1003. In block 1003, the component selects the next overridden language. In decision block 1004, if all the overridden languages have already been selected, then the component returns an error, else the component continues at block 1005. In block 1005, the component retrieves the content for the content identifier from the content for the overridden language and then loops to block 1002.

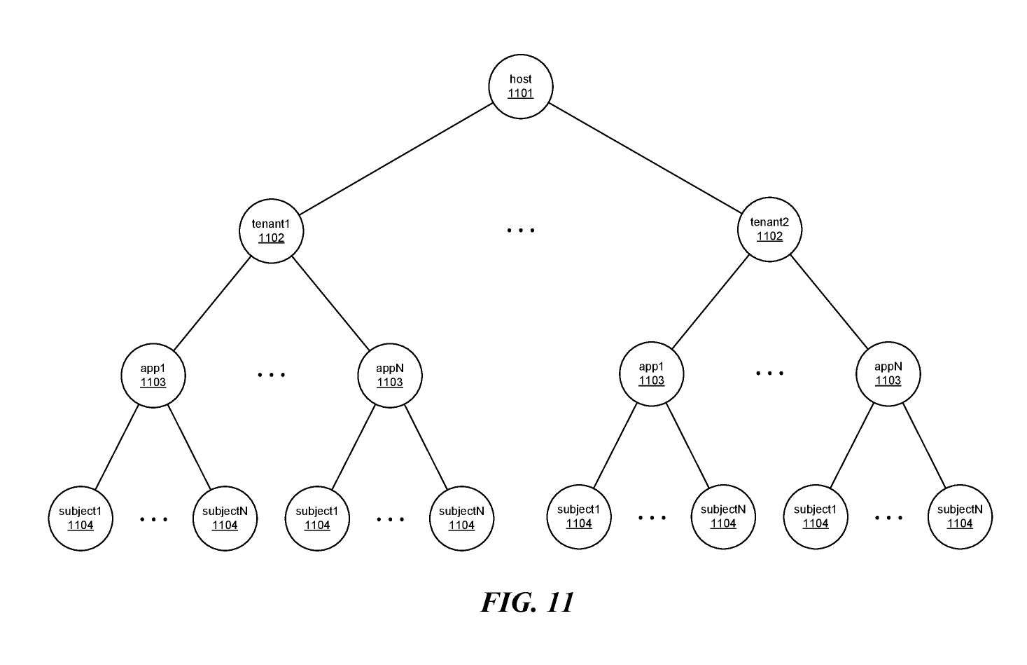

FIG. 11 is a hierarchy diagram illustrating a hierarchy of content defined by a host and application providers in some embodiments. A host may provide default content 1101 in a variety of languages. Each application provider may provide overriding content 1102 that overrides the content provided by the host for use by all of the applications of the application provider. Each application provider may also provide overriding content 1103 for each application that overrides the overriding content 1102 of the application provider. Each application provider may also provide overriding content 1104 for each subject for which content is defined for an application. When the customization system receives a request to customize a web page, the customization system identifies the preferred language and then, for each content identifier, determines whether the application provider has provided subject-level overriding content for the content identifier. If so, the customization system uses the content specified by the subject-level overriding content for that subject. If not, the customization system determines whether the application provider has provided application-level overriding content for the content identifier. If so, the customization system uses the content specified by the application-level overriding content for that application. If not, the customization system determines whether the application provider has provided any application provider-level overriding content for the content identifier. If so, the customization system uses the content specified by the application provider-level overriding content. If not, the customization system uses content for the content identifier from the default content provided by the host.

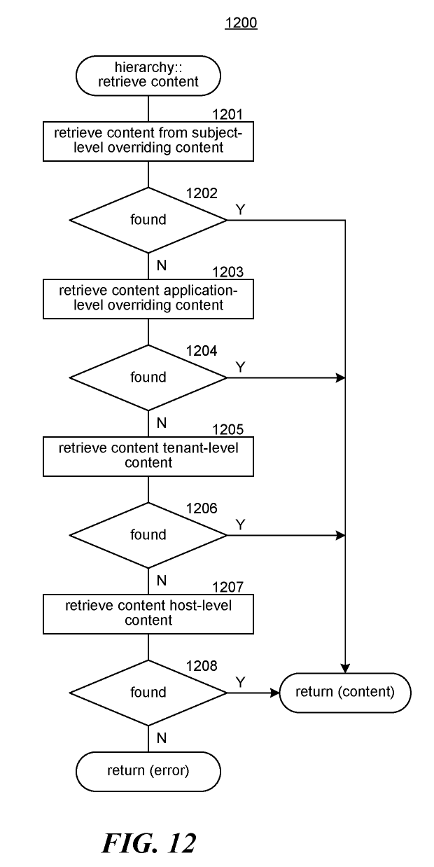

FIG. 12 is a flow diagram that illustrates processing of a retrieve content component using a hierarchy of overriding content in some embodiments. A retrieve content component 1200 processes each level of the hierarchy in sequence starting from the bottom of the hierarchy. In block 1201, the component retrieves the content for the content identifier from the subject-level overriding content, if any. In decision block 1202, if the content was found, then the component returns the content, else the component continues at block 1203. In block 1203, the component retrieves the content from the application-level overriding content if any. In decision block 1204, if content was found, then the component returns the content, else the component continues at block 1205. In block 1205, the component retrieves the content for the content identifier from the application provider-level content if any. In decision block 1206, if content was found, then the component returns the content, else the component continues at block 1207. In block 1207, the component retrieves content for the content identifier from the host-level content. In decision block 1208, if the content was found, the component returns the content, else the component returns an error.

The following paragraphs describe various embodiments of aspects of the customization system. An implementation of the customization system may employ any combination of the embodiments. The processing described below may be performed by a computing device with a processor that executes computer-executable instructions stored on a computer-readable storage medium that implements the customization system.

In some embodiments, a method performed by a computing system is provided for localization of a user interface provided by a host to applications of application providers for presentation to users of the applications. The method accesses default content provided by the host in a plurality of languages. The default content for a default language has content for content identifiers for the default language. The method accesses overriding content provided by the application providers. The overriding content for an application provider for a language has content for content identifiers for that language. The method receives from a user of a target application provider a request for a document. The document has one or more content identifiers for content to be included in the document. The method identifies a preferred language for content of the document. For each content identifier of the document, the method performs the following. When overriding content for the target application provider includes content for the content identifier in the preferred language, the method selects for the document the content for the content identifier of the overriding content for the preferred language for the target application provider. When overriding content for the target application provider does not include content for the content identifier in the preferred language, the method selects for the document the content for the content identifier of default content. In some embodiments, the document is a display page provided by the host as a service to application providers. In some embodiments, the preferred language is identified based on a link provided to the user of the target application provider by the target application provider. In some embodiments, the method further receives an indication of a custom content identifier for custom content of an application provider for the document wherein the overriding content for the application provider includes the custom content for the custom content identifier. In some embodiments, the method further accesses a priority ordering of different languages such that content for a content identifier of the document is selected from the content of the language with the highest priority. In some embodiments, when overriding content for an application provider and default content are provided in the same language, the method gives priority to the overriding content. In some embodiments, at least one language is a variant of another language. In some embodiments, the overriding content for an application provider is provided by a third party. In some embodiments, the overriding content for an application provider that is provided by a third party is hosted by the third party. In some embodiments, the overriding content is stored on multiple data sources and wherein the selecting of the content for the content identifier of the overriding content for the preferred language for the target application provider includes searching multiple data sources. In some embodiments, the default content is stored on multiple data sources and wherein the selecting of the content for the content identifier of the default content includes searching multiple data sources. In some embodiments, the method further accesses a specification of acceptable languages of an application provider such that content is presented to users of the application provider in an acceptable language. In some embodiments, the overriding content provided by an application provider reflects a policy specified by the application provider for overriding default content. In some embodiments, the accessing, receiving, identifying, and selecting are performed by a client-side component. In some embodiments, the accessing, receiving, identifying, and selecting are performed by a server-side component.

In some embodiments, a method performed by a computing system is provided for localization of a web page of an application provider of a host. The web page is provided by the host to a user of the application provider on behalf of the application provider. The method receives from a user of the application provider a request for the web page, the web page having content. The method identifies a preferred language for content of the web page. For content of the web page, when the application provider has specified content for the preferred language for the web page, the method to the web page the specified content, and when the application provider has not specified content for the preferred language for the web page, the method to the web page default content in the preferred language provided by the host. In some embodiments, the application provider provides a priority order of languages for searching for content for the web page. In some embodiments, the content for a language includes content for content identifiers and the web page is to include content for a target content identifier and wherein the content for the languages is searched in a priority order of language for first content that includes content for the target content identifier.

In some embodiments, a computing system is provided for customization of a web page provided by a service of a host. The computing system a computer-readable storage medium storing computer-executable instructions and a processor that executes the computer-executable instructions stored in the computer-readable storage medium. The instructions control the computing system to receive an indication to provide the web page to a user of an application provider of the host. For each of a plurality of content identifiers of content to be included in the web page, the instructions control the computing system to, when the application provider has specified application provider-specific content for the content identifier of the web page, indicate to add to the web page the application provider-specific content for the content identifier. And, the instructions control the computing system to, when the application provider has not specified application provider-specific content for the content identifier of the web page, indicate to add to the web page default content for the content identifier provided by the host. In some embodiments, the instructions further control the computing system to access multiple data sources to identify application provider-specific content for the content of the web page that the application provider has specified.

Although the subject matter has been described in language specific to structural features and/or acts, it is to be understood that the subject matter defined in the appended claims is not necessarily limited to the specific features or acts described above. Rather, the specific features and acts described above are disclosed as example forms of implementing the claims. Accordingly, the invention is not limited except as by the appended claims.

We claim:

1. A method performed by a computing system for localization of a user interface provided by a host to applications of application providers for presentation to users of the applications, the method comprising:
accessing default content provided by the host in a plurality of languages, the default content for a default language having content for content identifiers for the default language;
accessing overriding content provided by the application providers, the overriding content for an application provider for a language having content for content identifiers for that language;
receiving from a user of a target application provider a request for a document, the document having one or more content identifiers for content to be included in the document;
identifying a preferred language for content of the document; and
for each content identifier of the document,
when overriding content for the target application provider includes content for the content identifier in the preferred language, selecting for the document the content for the content identifier of the overriding content for the preferred language for the target application provider; and
when overriding content for the target application provider does not include content for the content identifier in the preferred language, selecting for the document the content for the content identifier of default content.

2. The method of claim 1 wherein the document is a display page provided by the host as a service to application providers.

3. The method of claim 1 wherein the preferred language is identified based on a link provided to the user of the target application provider by the target application provider.

4. The method of claim 1 further comprising receiving an indication of a custom content identifier for custom content of an application provider for the document wherein the overriding content for the application provider includes the custom content for the custom content identifier.

5. The method of claim 1 further comprising accessing a priority ordering of different languages such that content for a content identifier of the document is selected from the content of the language with the highest priority.

6. The method of claim 5 further comprising, when overriding content for an application provider and default content are provided in the same language, giving priority to the overriding content.

7. The method of claim 1 wherein at least one language is a variant of another language.

8. The method of claim 1 wherein the overriding content for an application provider is provided by a third party.

9. The method of claim 9 wherein the overriding content for an application provider that is provided by a third party is hosted by the third party.

10. The method of claim 1 wherein the overriding content is stored on multiple data sources and wherein the selecting of the content for the content identifier of the overriding content for the preferred language for the target application provider includes searching multiple data sources.

11. The method of claim 1 wherein the default content is stored on multiple data sources and wherein the selecting of the content for the content identifier of the default content includes searching multiple data sources.

12. The method of claim 1 further comprising accessing a specification of acceptable languages of an application provider such that content is presented to users of the application provider in an acceptable language.

13. The method of claim 1 wherein the overriding content provided by an application provider reflects a policy specified by the application provider for overriding default content.

14. The method of claim 1 wherein the accessing, receiving, identifying, and selecting are performed by a client-side component.

15. The method of claim 1 wherein the accessing, receiving, identifying, and selecting are performed by a server-side component.

16. A method performed by a computing system for localization of a web page of an application provider of a host, the web page provided by the host to a user of the application provider on behalf of the application provider, the method comprising:
receiving from a user of the application provider a request for the web page, the web page having content;
identifying a preferred language for content of the web page; and
for content of the web page,
when the application provider has specified content for the preferred language for the web page, adding to the web page the specified content; and
when the application provider has not specified content for the preferred language for the web page, adding to the web page default content in the preferred language provided by the host.

17. The method of claim 16 wherein the application provider provides a priority order of languages for searching for content for the web page.

18. The method of claim 16 wherein the content for a language includes content for content identifiers and the web page is to include content for a target content identifier and wherein the content for the languages is searched in a priority order of language for first content that includes content for the target content identifier.

19. A computing system for customization of a web page provided by a service of a host, the computing system comprising:
a computer-readable storage medium storing computer-executable instructions for controlling the computing system to:
receive an indication to provide the web page to a user of an application provider of the host; and
for each of a plurality of content identifiers of content to be included in the web page,
when the application provider has specified application provider-specific content for the content identifier of the web page, indicate to add to the web page the application provider-specific content for the content identifier; and
when the application provider has not specified application provider-specific content for the content identifier of the web page, indicate to add to the web page default content for the content identifier provided by the host; and
a processor that executes the computer-executable instructions stored in the computer-readable storage medium.

20. The computing system of claim 19 wherein the computer-executable instructions further control the computing system to: access multiple data sources to identify application provider-specific content for the content of the web page that the application provider has specified.
